(19) United States
(12) Patent Application Publication
(10) Pub. No.: US 2004/0013192 A1
(43) Pub. Date: Jan. 22, 2004

(54) Mobile live information system

(76) Inventor: Nicholas Kennedy, Eastbury (GB)

Correspondence Address: LAHIVE & COCKFIELD, 28 STATE STREET, BOSTON, MA, 02109, US

(21) Appl. No.: 10/198,184

(22) Filed: Jul. 17, 2002

(51) Int. Cl. H04B 1/66

(52) U.S. Cl. 375/240

(57) ABSTRACT

A mobile live information system consists of a digital video camera mounted in a vehicle. The signal is fed to a computer 10 which divides the datastream to be transmitted into a plurality of packets which can be simultaneously transmitted using a number of wireless modems connected in parallel. In a receiving portion, the video image and other imports are reconstructed and can be displayed live as an Internet or other broadcast. The system has other applications in electronic newsgathering and security.

### FIELD OF THE INVENTION

The present invention relates to the presentation and/or delivery of live information to and from a remote object.

Such a system has numerous commercial applications in sport, for example, to the transmission of video information showing the live driver's view from a moving rally car during competition; in newsgathering, and in security. The system is particularly well adapted to Internet broadcasting.

The system has applications to moving or remote objects of all types, especially where a wireless line is preferable to a fixed line connection. Although for the purposes of this specification the object will be assumed to be a vehicle and more particularly a rally car, the system can be provided in a sufficiently small format so that it can be carried by an individual such as an athlete or an inanimate object such as a newsgathering drone. The system can also be used in any type of vehicle including aircraft as well as cars and motorbikes. The system also has applications in electronic newsgathering (ENG) where it could be carried by a reporter. Whilst the application refers to “moving” devices, there is nothing to preclude the use of the system in a stationary setting, for instance in a stationary location where a wireless link is preferable to a fixed connection.

### BACKGROUND ART

In order to make a video film of the driver's view from a moving vehicle such as a rally car or other type of racing car, it is normally necessary to set up a line of sight microwave link to carry the data. This can produce acceptable and exciting images from cars racing on tracks but is of limited use when the vehicle is a rally car on a stage in forest conditions or the like.

Similar technical problems apply in newsgathering and security applications.

### SUMMARY OF THE INVENTION

In accordance with the present invention a mobile live information system comprises a mobile portion comprising one or more sources of digital information data, means for encoding the data into a compressed digital form, means for processing the compressed data into packets, and a plurality of digital wireless modems for simultaneously transmitting respective data packets to provide an increased bandwidth channel, and a receiving portion for reassembling the received data packets.

Additional aspects and features of the invention are defined in the appended claims.

The system of the present invention is advantageous since it does not require line of sight communications.

The information system preferably also provides a back channel, which has the advantage that interviews or conversations can be carried out with the driver or operator in real-time, and control information be sent. The information transmitted from the vehicle preferably also includes telemetry from systems such as the engine and suspension, which can be used to control a remote simulator to give the viewer the same physical experiences as the driver in a safe environment.

In a preferred embodiment the mobile system includes means for storing more data than can be transmitted live. This additional information can then be subsequently transmitted to provide higher quality video for recording and subsequent reporting.

With a system that is adapted to transmit data at multiple picture qualities as determined by the local operator or an operator at the base system making use of the back channel, a very low quality preview picture could be transmitted continuously during an event to the base system. This preview feed would require only minimal bandwidth. When a Director at the base system wished to use the picture from a particular mobile portion a signal could be sent to the mobile portion over the back channel to change the quality of transmission. This allows more data (video) sources to be running over a fixed number of available channels, with only one using high bandwidth dynamically when required. For example if an event organiser has 28 data channels available and a “preview” feed only requires 2 channels and a high quality feed needs 10, there could be 6 cameras with 4 of them in preview mode and the remaining 2 using a high quality feed. The 2 cameras transmitting at high quality would be the “live camera” from which a picture was being displayed and the camera that the Director wished to cut to next. This dynamic assignment of channels therefore allows much greater flexibility.

### BRIEF DESCRIPTION OF THE DRAWINGS

In order that the invention may be well understood an embodiment thereof will now be described, by way of example only, with reference to the accompanying diagrammatic drawings, in which:

FIG. 1 shows a diagrammatic view of a mobile portion of one embodiment of a mobile live information system;

FIG. 2 shows a diagrammatic view of a receiving portion for use with the mobile portion in FIG. 1; and

FIG. 3 shows a base system or control centre.

### DETAILED DESCRIPTION OF THE EMBODIMENT

A mobile live information system comprises a mobile portion and a receiving portion. The receiving portion may be provided as an Internet service provider (ISP)'s dial-up access point (point of presence).

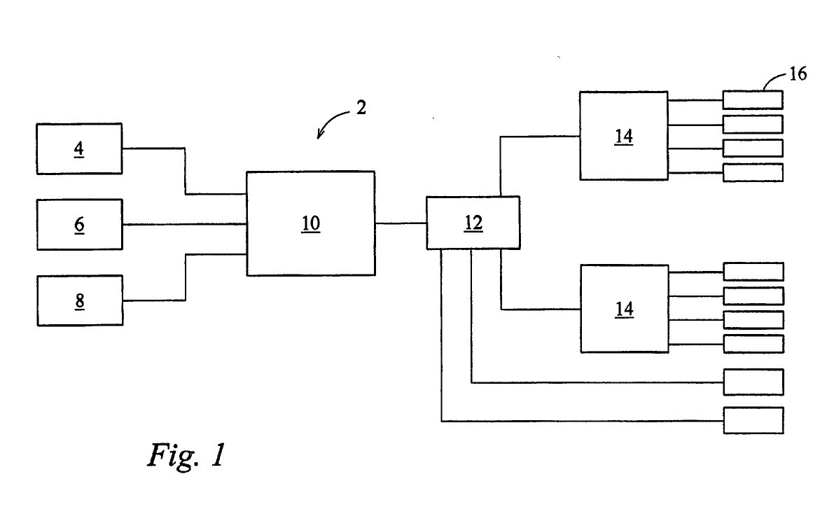

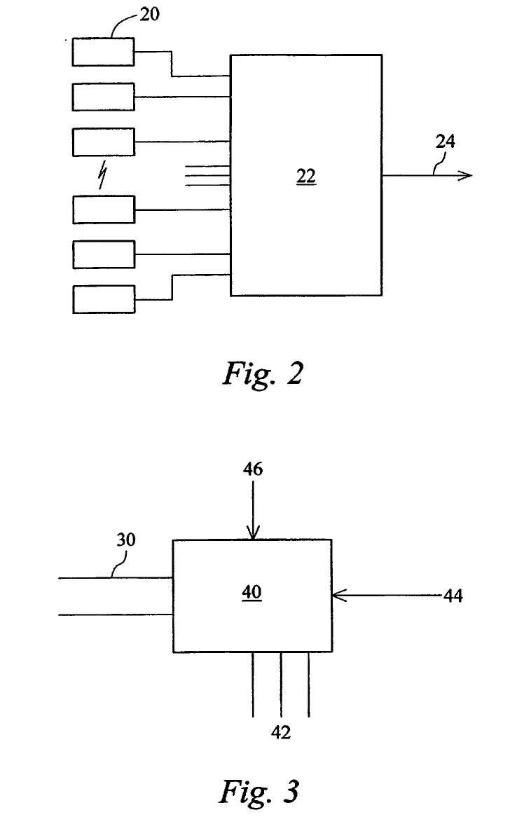

The mobile portion shown in FIG. 1 incorporates an input section, a data processing section and a transmitter. The receiving portion as shown in FIG. 2 includes receiver means and an output section so that the information can be supplied to its ultimate destination, which could be an Internet site so that video information could be broadcast live on the Internet, a local large screen display at the trackside for spectators, a simulator, or conventional broadcaster or news organisation or even several of the above.

Mobile Portion

The mobile portion comprises an input section, a data processing section and a transmitter.

Input Section

As shown in FIG. 1, the mobile portion 2 has inputs for the information to be transmitted over the system. These include a video camera 4, an audio input from a microphone 6 and telemetry inputs 8. A record switch (not shown) may be associated with the video camera so that an operator of the mobile portion can determine when to turn the camera on and off. The switch may also be controlled by a remote operator at the base system making use of the back channel.

The telemetry inputs 8 can be provided from various sources including a co-driver's computer which can supply several data types including speed, time and fuel level etc. A further source of telemetry inputs are position sensing inputs. These can be derived from GPS, gyro and dead reckoning compass systems that produce position and velocity.

The system has the capability to store data at a higher rate than it can transmit, for transmission at a later time. This could (for example) be to tape or a solid-state recorder. The solid-state recorder is preferable since it withstands mechanical shock well and is capable of storing a large amount of data. A recordable CD or DVD RAM could also be used. If a mechanical tape system is used a hard disk and/or RAM buffer should be in place to allow instant recording as soon as the record switch is depressed. This is required because there will be a delay in the mechanical tape system locating the required section of tape when the switch is depressed.

Where the information system is to be used to supply data to a simulator for simulation of the vehicle at a remote location, live or at a later date once such data has been analysed, then the telemetry inputs 8 may also include some or all of the following: wheel speed sensing, suspension position and acceleration sensing, acceleration and orientation and relative orientation sensing at one or several points of the vehicle; telematic equipment, position sensing (GPS, dead reckoning, ground radar or laser tracking) and inertial sensing.

Data Processing Section

The data processing section is provided by a programmable computer 10. In this embodiment, a laptop is used such as the Sony® VAIO® for its small size and its integral FireWire input, which is capable of accepting direct input from a DV (digital video) camcorder or CCD cameras which may be used as the camera 4. Note that a FireWire input is equivalent to an I-link or IEEE 1394 input.

The inputs 4,6 and 8 may be direct to the computer or may be on a universal serial bus (USB).

The computer 10 takes the various input data and packages it so that it can be transmitted over a wireless link. In the present embodiment the wireless link is a GSM telephone system using multiple lines. Essentially, any system which uses RF multiplexing technology and bespoke hardware and software to increase the data bandwidth can be used.

Data encoding and decoding can also be used on the transmission channel to obtain further bandwidth compression. Each packet of data transmitted carries an address so that it is possible to recreate at the receiver the original datastream even when packets arrive out of order. Error correction may also be employed to restore or cover for packets lost or damaged en route. Redundancy may also be introduced into the packet multiplexing algorithm.

The particular advantage of this sytem over existing video transmission systems is that by using multiple channels each channel will be required to transmit less data than one single channel would. Therefore each of these channels can operate at a lower data rate than a single channel system. Since the data capacity is proportional to the frequency the carrier, the carrier frequency can be lowered. Therefore since this is a system operating at a lower frequency than a single channel (microwave) system it will have much greater penetration and range than a single channel system. Conversely we achieve a higher overall bandwidth at a specific frequency than would otherwise be available.

The software used for taking the input data and placing it into an appropriate packet structure depends on the inputs and can take various forms as would be appreciated by a man skilled in the art of communications. For example, the Microsoft® Media Encoder or Real Video (trade mark), CUSeeMe (trade mark) or MPEG data encoding may be employed. A data recording system may also be provided in the computer 10.

The computer software may also provide that as soon as the live feed is terminated or there is sufficient bandwidth available for transmission of additional data because, e.g. the record button is released or the picture is still, the system can be arranged to transmit, sections of data from the higher quality recording to the base system at the quality requested. This allows dropouts in the live recording to be filled. It also allows an edit to be made with the reduced quality and/or preview footage that will then automatically be replaced with a higher quality footage as it becomes available. The system will prioritise the footage requested by the editor or an automated system at the base system for transmission. Low priority or archive footage may be transmitted at a later time, or by a lower cost medium such as landline or courier

The system may also, in conjunction with control data returning to the remote system, be set such that if the transmission is lost, then video stored in the buffer is transmitted first. That is to say that the transmission becomes delayed but remains complete and in order. Whether this or keeping the transmission relatively “live” is preferable may vary from situation to situation, and the system may be varied accordingly.

The computer 10 may also include software which provides automatic adjustments to the camera picture and level setting for audio signals. Manual pre-mixing of the inputs may also be provided for.

Transmitter

In the embodiment illustrated, modem teaming is employed. A USB bus 12 with several USB to serial adapters 14 (two shown) each linked to a GSM modem 16 provides the required number (in this case ten) of parallel channels which each simultaneously transmit to the receiving portion providing the required bandwidth. Radio or satellite modems could also be used.

Where the receiving portion is in an ISP then a MultiLink Point to Point protocol (ML-PPP) connection may be established.

Where a GSM service is used, this may be established as non-public access and provide a direct link to an ISP. It will be appreciated that the ISP service must allow multiple connections, or a system for splitting data packets over multiple ISPs could be used.

In an alternative embodiment, the data may be multiplexed using Eureka 147 (DAB protocol). The DAB protocol offers a multiplexing technology designed to handle multi-path multi-transmitter systems. The use of this protocol requires a radio frequency licence. However, it may be possible to obtain permission to use a particular frequency in a restricted area and/or timeframe. Other proprietary protocols, systems and frequencies may also be used as will be appreciated by man skilled in the art.

While GSM is a readily available technology now that there is good geographical coverage, the system is capable of working with any data transfer system that can offer a modem link. Other alternatives include radio packet technology e.g. TETRA, which offers the benefits of lower frequency. Good geographical coverage, data capability and cell handover are supported. Hardware for data modems is readily available for this technology.

Satellite data systems, e.g. Inmarsat or Iridium could be employed. These are currently limited to low data transfer rates to moving vehicles, but have greater capabilities for non-moving systems.

A combination of the above technologies could also be employed so that, for example, the video part of the data collected by the mobile portion could be transmitted via a GSM system while another system would use the audio or telemetry inputs. The split does not need to be source dependent. For example 1/2 video and ⅓ of audio could go by GSM and a ¼ video and 2/3 audio by Iridium with a ¼ video by TETRA. The system can pump data over whichever channel is open. Packet priority may be set in order to dictate which channel is used. Since some parts of the system are time critical and increasing the load on the data stream by channelling several systems down one stream may cause disruption several systems can be used running in parallel. Separation of the video/audio, the telemetry data and back channel may be desirable.

In a sophisticated system, it may be possible for the most important datastream or the most important packets of the datastream to be given a greater priority. A two (on-off) or multilevel priority system could be used. This prioritisation may be used in the transmission multiplex to make sure that the most important data gets to the receiver and gets there by the most reliable or higher speed route. This may be to prioritise complete frames over frame updates or to prioritise dropped low resolution frames above high-resolution versions of previously transmitted frames.

Receiving Portion

In the receiving portion illustrated in FIG. 2, which may be located at an ISP, a number of modems 20 is provided. The number of modems 20 corresponds to at least the number of modems 16 employed in the mobile portion. It may be necessary to provide more modems at the base system depending on how quickly a modem 20 drops out and resets in relation to a modem 16 when an incoming signal is lost. Each modem receives one channel and feeds the received data to a Windows NT server 22 which uses specially programmed software to demultiplex the incoming signals and creates a recombined single data stream at the output. As shown, the output from the server 22 is fed along a high-speed link 24, usually a high ISDN landline or satellite link, which provides a live feed to a base system as shown in FIG. 3. Alternatively, the live feed can go directly to a uni- or multicast system via an ISP.

A spoofing system may be necessary to allow the system to work. This fools the computer at each end of the transmission line into believing that they are still connected even when the connection has been lost. Further buffering can be applied in the mobile portion to allow data to be held until transmission is possible again. For the live application a rolling buffer could be used. This will overwrite the oldest data regardless of whether it has been sent and not send a buffer full signal that may cause problems with the mobile portion of the system. Buffering and spoofing will take place before the stream is split to the multiple modems. If buffering and spoofing were placed after the split this would result in the modem teaming software being unaware of which modems were connected and which packets had been successfully sent.

A Windows NT server is given as an example only.

Base System

The base system provides for the decoding of the data stream in order to feed the live broadcast system, whether on conventional broadcast media or on the Internet. The base system can also be used to control a simulator. The base system can further provide for long-term storage and improvement of the data for delayed transmission. The base system also controls the back channel to the mobile portion that can be used to control parameters of the camera or to provide audio feedback to the operator at the mobile portion.

The data out port on link 24 from the receiving portion is received online 30 at the base system. The base system includes a computer 40 giving video, audio and other outputs 42. A back channel has an audio input 44 and provides for operation control by means of inputs 46.

The back channel can be used to send data over the same link so that interviews with the crew of the vehicle in which the mobile portion is located can be carried on. The back channel can also be used for remote control of on-board systems such as adjustment of camera settings, audio mix control and adjustment of vehicle systems. This latter task may require a suitable machine control protocol.

Method of Use in Simulation

The system can be used to drive a fairground type simulation ride to follow the movements and forces of the vehicle almost as it happens.

The application of GPS and map following technology (provided by the telemetry inputs) would further enhance the system. If a 3D model is created from a map the car's position and attitude can be placed on the map in order to enable artificial views to be created from limitless viewpoints. By using multiple cameras and stereoscopy or other 3D imagine techniques an artificial landscape in the area that has been scanned by the on board systems camera, or by other camera linked to the system can be enhanced.

The simulation could be presented upon a dedicated system, or created upon a home or other computer. The simulation data could be fed into a computer game console or system enabling the home user to either watch, race against, or otherwise interact with the participants of the live event.

Data could be stored for later recreation of the events. Such data might be used for evidence gathering, crash investigation, or for security monitoring of transport fleets for instance security vans.

Variations

In a commercial application to security, a police motorbike could carry the system in order to transmit live video via the GSM network. It is even possible to consider mounting a small video camera on a mounted police officer's helmet, which could be of significant value in riot situations.

The system could be utilised as part of a car alarm, to transmit images to the owner and/or police should the alarm be triggered, or to allow the owner to view video from the vehicle from a remote location—for instance either by direct dialling or via the internet.

Similarly, the system can be used in a personal attack alarm or for protection or surveillance of any installation where the use of a fixed line is inappropriate.”

Such a system may reduce the number of false alarms raised, and increase the number of convictions attained. Security camera footage retained on site will always be vulnerable to theft or destruction by the criminals that have triggered the alarm. By transmitting images as soon as the alarm is triggered, an off site record is available for police use. The use of buffer so that images are always being captured locally before the alarm is triggered is recommended, so that this frame store of events preceding the trigger event is also transmitted to the remote location once the alarm is triggered.

Since the system may be reduced to a very small size, it is conceivable that the mobile portion could be a handheld system. The lowest quality data feed required for video over TCP/IP is 28.8 KBPS and this matches the highest current connect speed for a single PCMCIA GSM data modem. An ENG adapted mobile portion could therefore have a handheld camcorder, a belt mounted Sony VAIO® together with a NOKIA ORANGE® data modems fitted. Further, with control software, this system is capable of feeding off air high-quality video from tape to studio outlined above. The VAIO® has an independent audio in and out which may be used for studio to reporter communication on the back channel. Such a system could be specifically build as a single unit and in that case it will be relatively straight forward to build more modems into the system to improve the data rate and allow further input types. Any reporter with such a system would be able to transmit live video within the reception area of the GSM network. In conjunction with data recording, the reporter would be able to deliver high-quality recorder video without the need to reach a landline. The system could also incorporate the landline option by use of the PCMCIA slot, Ethernet or Fire Wire.

Although the use of purely wireless transmission makes the system mobile, it could also be used as a temporary static security camera which does not require cable to be laid to it. This would have applications, for instance, at rock festivals and gatherings in remote areas.

1. A live information system comprises a remote portion comprising one or more sources of information, means for encoding the information into a compressed digital form, means for processing the compressed data into packets, and a plurality of digital wireless modems for simultaneously transmitting respective data packets to provide an increased bandwidth channel, and a receiving portion for reassembling the received data packets.

2. A live information system as claimed in claim 1, further comprising a back channel for transmitting from the receiving portion to the remote portion.

3. A live information system as claimed in claim 1, wherein the sources of information are selected from video data, audio data, telemetry data relating to a vehicle in which the mobile portion is mounted.

4. A live information system as claimed in claim 1, wherein the remote portion further comprises means for storing digital information data of higher resolution than that which is processed for live transmission.

5. A live information system as claimed in claim 4, further comprising means for transmitting the stored digital information data of higher resolution than that which is processed for live transmission when bandwidth is available.

6. A live information system according to claim 1 in which the remote portion is mobile.

7. A live information system including a remote portion comprising a video camera, means for compressing, encoding and processing the data into a compatible digital data stream and at least one digital wireless modem, and a receiving portion for receiving and decoding the data stream.

8. An information system comprising a remote portion comprising of one or more sources of information, means for encoding the information into a digital form, means for processing the compressed data into packets, and a plurality of digital wireless modems for simultaneously transmitting respective data packets to provide an increased bandwidth channel, and a receiving portion for reassembling the received data packets.

9. A simulator comprising a user feedback station equipped with at least one of a video image generator and a motion generator, and a remote unit, the user feedback station and the remote unit being linked via a means for encoding information produced at the remote unit into a compressed digital form, means for processing the compressed data into packets, and a plurality of digital wireless modems for simultaneously transmitting respective data packets to provide an increased bandwidth channel, and a receiving portion for reassembling the received data packets and feeding them to the user feedback station to replicate conditions at the remote unit for the user.

10. A simulator comprising a user feedback station equipped with at least one of a video image generator and a motion generator and a wireless data link to a mobile vehicle taking part in a sporting event, the user feedback station being equipped with at least one of an image and a motion generator to reproduce for a user conditions at the mobile vehicle.

11. A simulator according to claim 10 in which the user feedback station includes game software whose rules correspond to those of the sporting event thereby to allow the user to compete against the mobile vehicle.

12. A simulator system comprising a user feedback station equipped with at least one of a video image generator and a motion generator and a data link to a remote system, the user feedback station being equipped with at least one of an image and a motion generator to reproduce for a user to be relayed live or recorded conditions at the mobile vehicle.

13. A unit for connection to a computer as a modem, including a processor and a plurality of internal or external wireless modems, arranged such that it provides functionality to the computer equivalent to a single modem, but allows a higher bandwidth connection to another such device or equivalent device than could otherwise be obtained by spreading data across the plurality of modems.

14. A method of assigning limited bandwidth to several units capable of low and high bandwidth transmission, such that switching of low and high bandwidth transmissions from each unit can be selected in order to maximise utilisation of the available bandwidth.
